(19) United States
(12) Patent Application Publication
(10) Pub. No.: US 2011/0101017 A1
(43) Pub. Date: May 5, 2011

(54) DISPENSER FOR SOFT PLIABLE LIDS

(76) Inventors: Roy D. Schroeder, Columbus Grove, OH (US); Chris Rode, Delphos, OH (US)

(21) Appl. No.: 12/917,686

(22) Filed: Nov. 2, 2010

Related U.S. Application Data
(60) Provisional application No. 61/257,575, filed on Nov. 3, 2009.

(51) Int. Cl. B65D 83/08; B65G 59/06; B65H 3/00

(52) U.S. Cl. 221/1; 221/42; 221/45; 221/36

(57) ABSTRACT

A lid dispenser includes a housing, shaft assemblies and a lid dispensing mechanism. Each shaft assembly includes a shaft that extends from a base of the housing, a lid shelf that supports at least a bottom-most lid in the lid stack area and a drive gear about its shaft so that rotation of the drive gear causes rotation of the associated shaft and lid shelf. A common gear is positioned so as to mesh with each of the drive gears such that rotation of the common gear causes corresponding rotation of each of the drive gears. Manual operation of the lid dispensing mechanism causes the common gear to rotate each of the shafts sufficient to allow the lid shelves to dispense the bottom-most lid. Release of the lid dispensing mechanism rotates the common gear back to a default position, rotating each of the shaft assemblies back to their default position.

### CROSS REFERENCE TO RELATED APPLICATIONS

This application claims the benefit of U.S. Provisional Patent Application Ser. No. 61/257,575 filed Nov. 3, 2009, the disclosure of which is hereby incorporated by reference in its entirety.

### BACKGROUND

The present invention relates in general to dispensing devices and in particular to devices for dispensing flexible lids for containers.

Many restaurants, convenience markets and other establishments serve items including beverages and food to customers in paper, plastic, Styrofoam, and other disposable containers. As a convenience to the customers, a corresponding disposable lid is typically sealed around an open end of such containers to keep their contents from spilling or otherwise upsetting. In many establishments, the disposable lids are kept in generally horizontal or slightly inclined trays that are positioned near the location where their associated containers are dispensed. However, lids provided in such trays sometimes stick together causing slow downs in retrieving a single lid from a corresponding lid tray.

Further, a person typically touches several lids when attempting to retrieve a single lid. For example, a person wishing to obtain a lid from a conventional lid tray must typically grasp multiple lids, often requiring the use of two hands to separate out a single desired lid. This practice creates the likelihood that the counter on which the lid tray is positioned will become cluttered with loose lids lying in the proximity to the lid tray. Still further, typical lid trays consume considerable amounts of valuable counter space thus affecting the store space required to serve beverages.

### BRIEF SUMMARY

According to aspects of the present invention, a lid dispenser is provided that is operative to dispense a single lid at a time. More particularly, a lid dispenser for sequentially dispensing flexible lids includes a housing, a plurality of shaft assemblies and a lid dispensing mechanism. The housing includes a housing base, a lid stack area for storing a substantially vertical stack of lids and a lid discharge area arranged to receive a bottom-most lid dispensed from the lid stack area.

The plurality of shaft assemblies are arranged in a pattern that facilitates stacking and storing a substantially vertical stack of lids there between, e.g., in the lid stack area. During operation, a bottom-most lid dispensed from the lid stack area is delivered to an operator accessible location of the lid discharge area in response to manual operation of the lid dispensing mechanism.

Each shaft assembly includes a generally vertically extending shaft. A lid shelf is positioned along the shaft that normally supports at least the bottom-most lid in the stack of lids above the lid discharge area when the lid dispensing mechanism is not being operated. Additionally, a drive gear is attached about its corresponding shaft proximate to the base of the housing so that rotation of the drive gear causes corresponding rotation of the attached shaft and corresponding lid shelf.

A common gear is positioned proximate to the base so as to mesh with each of the drive gears in such a manner that rotation of the common gear causes corresponding rotation of each of the drive gears. Moreover, each drive gear rotates in substantially equal amounts in the same direction. Further, the lid dispensing mechanism, which is manually operable between at least a non-actuated state and an actuated state, is geared to the common gear. Manual operation of the lid dispensing mechanism from the non-actuated state to the actuated state thus causes the common gear to rotate sufficient to rotate each of the plurality of shaft assemblies in such a manner as to cause the lid shelf or shelves, to release the bottom-most lid in the stack of lids loaded into the lid stack area. The released lid thus falls towards the discharge area.

As the bottom-most lid is released, the remainder of the lids in the stack of lids are supported within the lid stack area between the shaft assemblies. When the lid dispensing mechanism is released, the common gear rotates the shaft assemblies back to their default position so that the lid shelves once again support the new bottom-most lid.

According to further aspects of the present invention, a method of dispensing a lid from a stack of lids when an operator depresses a handle, comprises pre-loading a stack of lids between a plurality of shaft assemblies in a non-activated position such that the stack of lids rests on a plurality of lid dispensing flanges, the stack of lids comprising a bottom-most lid and a remaining portion of lids. The method also comprises rotating the plurality of shaft assemblies to an activated position such that the plurality of lid dispensing flanges rotates such that the stack of lids does not rest on the lid dispensing flange, the bottom-most lid to falls to a lid discharge area and a compression portion of the plurality of shaft assemblies compresses the remaining portion of lids such that the remaining portion of lids is suspended and does not fall to the lid discharge area.

According to still further aspects of the present invention, a lid dispenser for sequentially dispensing flexible lids, comprises a plurality of vertically extending shaft assemblies arranged in a pattern that facilitates stacking a plurality of lids there between, the plurality of lids including a bottom-most lid and a remaining portion. In this regard, the plurality of shaft assemblies includes at least two positions: an activated position and a non-activated position. Moreover, at least one of the plurality of shaft assemblies includes a lid shelf and a compression portion. The lid shelf is positioned along the shaft and is arranged such that, when the plurality of shaft assemblies is in the non-activated position, the lid shelf supports at least the bottom-most lid positioned within the plurality of shaft assemblies, and when the plurality of shaft assemblies is in the activated position, the lid shelf does not interfere with the bottom-most lid, thus allowing the bottom-most lid to fall free. The compression portion is configured such that, when the plurality of shaft assemblies is in the activated position, the compression portion compresses the remaining portion of the plurality of lids and suspends the remaining portion of the plurality of lids from falling free.

### BRIEF DESCRIPTION OF THE SEVERAL VIEWS OF THE DRAWINGS

FIG. 1 is a perspective front view of a lid dispenser for manually dispensing flexible lids according to various aspects of the present invention;

FIG. 2 is a side view of the lid dispenser of FIG. 1, according to various aspects of the present invention;

FIG. 3 is a top view of the lid dispenser of FIG. 1, according to various aspects of the present invention;

FIG. 4 illustrates a section of the lid dispenser of FIG. 1, where select components are removed to illustrate certain lid dispensing features, according to various aspects of the present invention;

FIG. 5 is an illustration of the relationship between a common gear, a bevel gear assembly in cooperation with the common gear and a plurality of drive gears, each drive gear meshed with the common gear within the lid dispenser of FIG. 1, according to various aspects of the present invention;

FIG. 6 is an illustration of a section of the dispenser of FIG. 1 where select components and features are removed to illustrate a dispensing mechanism handle arrangement of the lid dispenser, according to various aspects of the present invention;

FIG. 7 is an illustration of lid shelves within the lid dispenser of FIG. 1, according to various aspects of the present invention;

FIG. 8 is a top view of shaft assemblies of the lid dispenser of FIG. 1 in a non-actuated position, according to various aspects of the present invention;

FIG. 9 is a top view of the lid dispenser of FIG. 1, illustrating the shaft assemblies in an actuated position, according to various aspects of the present invention;

FIG. 10 illustrates the lid dispenser of FIG. 1, holding a stack of lids according to various aspects of the present invention; and

FIG. 11 illustrates the lid dispenser of FIG. 1, discharging a bottom-most lid of a stack of lids according to various aspects of the present invention.

### DETAILED DESCRIPTION

In the following detailed description of the preferred embodiments, reference is made to the accompanying drawings that form a part hereof, and in which is shown by way of illustration, and not by way of limitation, specific preferred embodiments in which the invention may be practiced. It is to be understood that other embodiments may be utilized and that changes may be made without departing from the spirit and scope of the present invention. Further, like structure is referred to with like reference numerals throughout.

According to various aspects of the present invention, a lid dispenser is provided for dispensing flexible lids. More particularly, the lid dispenser provides the ability to separate and dispense an individual flexible lid from a stack of lids. In an illustrative implementation, the lid dispenser uses vertically mounted shafts to define a framework that contains and guides the stack of lids, e.g., from a lid storage area towards a lid discharge area of the lid dispenser such that a single lid is dispensed from the lid storage area to the dispending area each time a corresponding lid dispensing mechanism is manually operated by a user.

The stack of lids, when inserted into the lid dispenser, is oriented between the shafts and is supported within the lid storage area by corresponding lid shelves that are mounted on the shafts so as to be spaced from a base of a corresponding lid dispenser housing, e.g., proximate and above a lid discharge area of the lid dispenser. The lid shelves also include escapement features for sequentially dispensing a bottom-most lid from the lid stack to the lid discharge area upon manual operation of the lid dispenser, as will be described in greater detail herein.

When an operator produces the required motion to trigger a lid dispensing mechanism of the lid dispenser, the shafts and lid shelves (functioning as escapement components) each rotate a sufficient amount to allow the bottom-most lid from the stack of lids to fall from the stack into the lid discharge area, which may be implemented, for example, as a chute that holds the discharged lid until the user removes the lid from the lid dispenser 10.

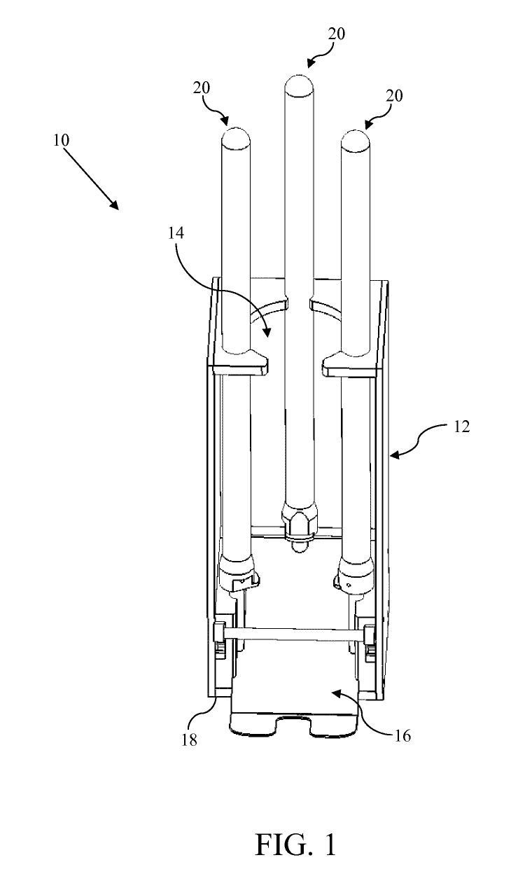

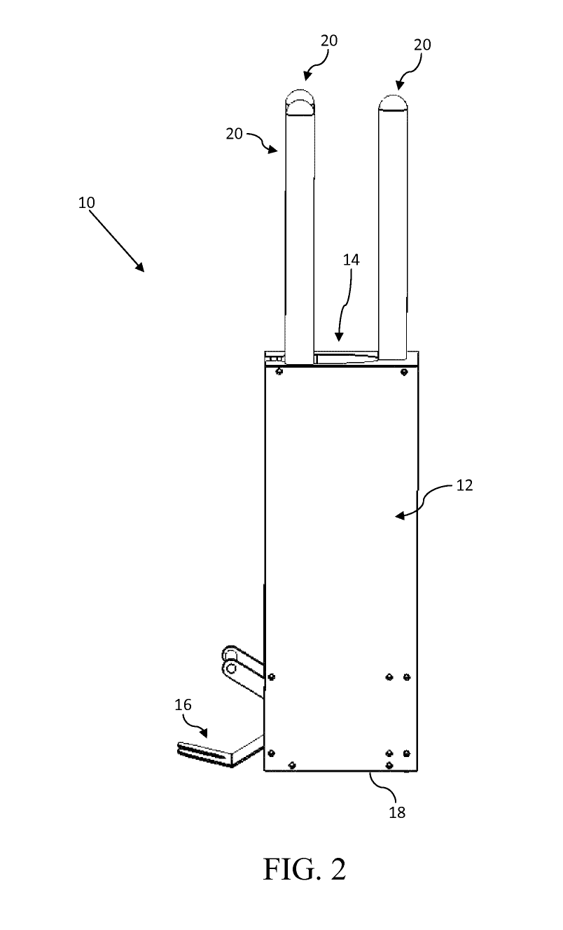

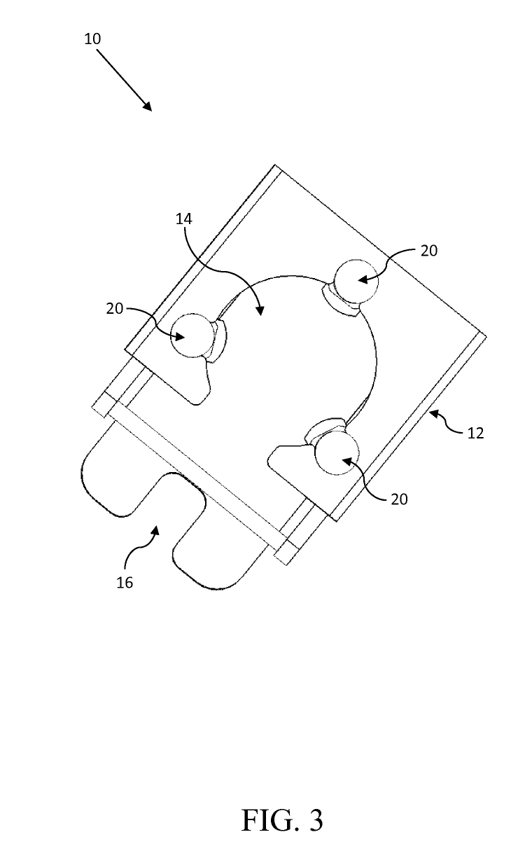

Referring to FIGS. 1-3, a lid dispenser 10 according to various aspects of the present invention includes in general, a housing 12 having a lid stack area 14, a lid discharge area 16 and a housing base 18. The lid stack area 14 provides an area utilized by the lid dispenser 10 for storing a substantially vertical stack of lids (not shown in FIGS. 1-3). The lid dispenser 10 is arranged to deliver a bottom-most lid dispensed from the lid stack area 14 to an operator accessible location of the discharge area 16 in response to manual operation of a lid dispensing mechanism of the lid dispenser 10. In this regard, the lid discharge area 16 may include a portion that is aligned generally coaxially with the lid stack area 14, but may also include additional features, such as a lid chute to transition a discharged lid to the operator accessible location.

The lid dispenser 10 also includes a plurality of vertically mounted shaft assemblies 20 arranged in a pattern that corresponds with the lid stack area 14. More particularly, the plurality of shaft assemblies 20 are arranged in a pattern that facilitates stacking and storing a substantially vertical stack of lids there between, thus defining the lid stack area 14. Although illustrated with three shaft assemblies 20, any reasonable number of shaft assemblies 20 may be utilized, depending upon the specific implementation of the lid dispenser 10.

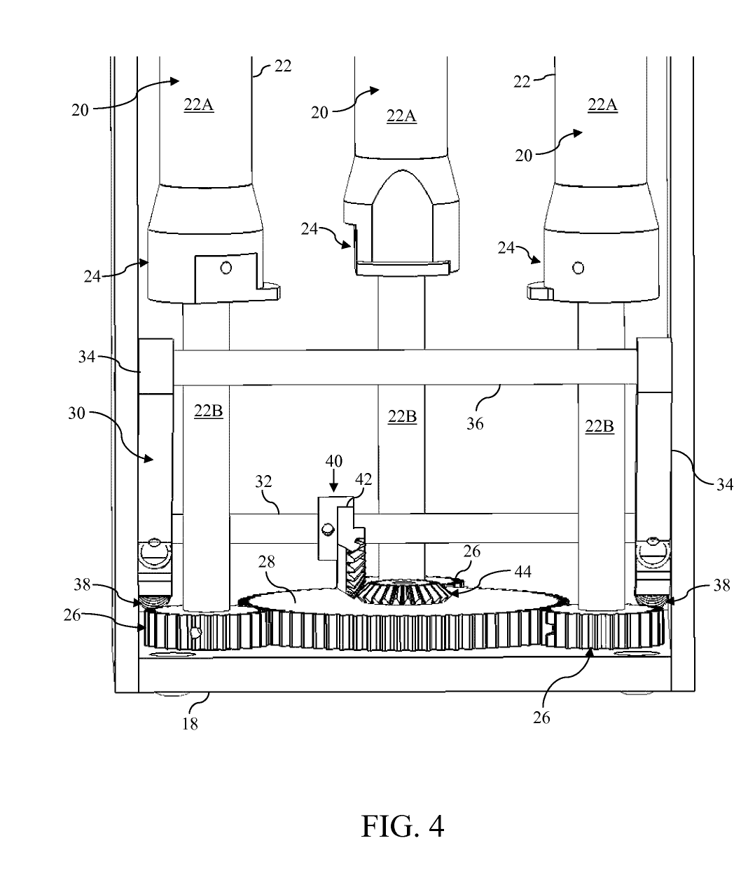

Referring to FIG. 4, a section of the lid dispenser housing 12 has been removed to better illustrate features of the lid dispenser 10 according to various aspects of the present invention. In the illustrative implementation, each shaft assembly 20 includes a generally vertically extending shaft 22 arranged so as to extend from the base 18 of the housing. Each shaft 22 includes an upper shaft section 22A that has a larger diameter that an associated lower shaft section 22B. However, in practice, other arrangements may be utilized. Moreover, each shaft 22 may be implemented as a generally cylindrical rod or have other physical attributes, including a non-circular cross-section.

The shafts 22 may define a framework that contains and guides a stack of lids held by the lid dispenser 10, toward the lid discharge area of the lid dispenser 10. The shafts 22 may also facilitate properly loading and positioning a stack of lids within the lid stack area 14 of the lid dispenser 10. For example, a worker may position a lid stack over the lid dispenser 10 and slide the lid stack between the shafts 22. In this regard, the shafts 22 guide the stack of lids and assist in maintaining the lids in a substantially vertical stack.

Each shaft assembly 20 also includes a lid shelf 24 positioned along the shaft 22. As noted in greater detail herein, the lid dispenser 10 is particularly suited for serially dispensing a bottom-most lid from a substantially coaxially aligned stack of lids. In this regard, the stack of lids may be lowered into the lid storage area 14 of the lid dispenser 10 until the bottom-most lid in the stack of lids is brought into cooperation with the lid shelves 24. Thus, the stack of lids, when inserted into the lid dispenser 10, is held upright in a substantially vertical stack by the shafts 22 and the stack of lids is supported by the corresponding lid shelves 24. As will be described in greater detail below, the lid shelves 24 support at least the bottom-most lid in the lid stack area 14 above and proximate to the lid discharge area 16 of the lid dispenser 10. The lid shelves 24 will be described in greater detail herein.

Each shaft assembly 20 also includes a drive gear 26 attached about shaft 22 proximate to the base 18 so that rotation of the drive gear 26 causes corresponding rotation of the attached shaft 22 about a fixed, substantially vertical axis. In this regard, each shaft 22 may be keyed or otherwise coupled to its corresponding drive gear 26. An end section of each shaft 22 may terminate about the base 18 of the lid dispenser housing 12 using any practical techniques. For example, an end portion of each shaft 22 may journal into the base 18 so as to support the corresponding drive gear 26 in a position just above the base 18. Moreover, bearings and/or other friction reducing techniques may be utilized to allow each shaft 22 to be rotatable about a substantially vertical axis.

According to an aspect of the present invention, each drive gear 26 cooperates with a common gear 28. For example, as illustrated, the common gear 28 is positioned proximate to the base 18 so as to engage and mesh with each of the drive gears 26. Accordingly, rotation of the common gear 28 causes corresponding rotation of each of the drive gears 26. The common gear 28 may include a shaft, mandrel, pin or other arrangement that positions the common gear 28 into a set position within the housing 12 of the lid dispenser 10 for rotation about a fixed, substantially vertical axis. Thus, the common gear 28 and each drive gear 26 rotate in the same plane, e.g., a generally horizontal plane. Moreover, because each drive gear 26 and the common gear 28 all have fixed centers (fixed axis of rotation), and because each of the drive gears 26 meshes with the common gear 28, the common gear 28 rotates in a direction that is opposite of the drive gears 26 and each of the drive gears 26 rotates in the same direction.

By way of illustration, each drive gear 26 and the common gear 28 may comprise a spur gear. In an exemplary implementation, each drive gear 26 may be substantially identical in dimension and characteristics so that each corresponding shaft 22 rotates by the same amount when caused to rotate by the common gear 28. The drive gears 26 and the common gear 28 may be of any other type of gear, including but not limited to, helical and double helical gear arrangements. The drive gears 26 and the common gear 28 may alternatively be replaced by another structure, such as using one or more belts or other coupling arrangements so long as the shafts 22 can rotate suitably to dispense a bottom-most lid.

A lid dispensing mechanism 30 is coupled to the common gear 28 so that manual operation of the lid dispensing mechanism causes the common gear 28 to rotate. According to various aspects of the present invention, the lid dispensing mechanism 30 is manually operable between at least a non-actuated state and an actuated state. More particularly, manual operation of the lid dispensing mechanism 30 from the non-actuated state to the actuated state causes the common gear 28 to rotate in a first direction. Rotation of the common gear 28 causes each of the drive gears 26 to rotate by an amount sufficient to correspondingly rotate their corresponding shafts 22 and lid shelves 24 so as to release a bottom-most lid from a stack of lids loaded in the lid dispenser 10. In the illustrative example, because each drive gear 26 is meshed to the common gear 28, each shaft 22 will rotate in the same direction. Rotation of the shafts 22, in turn causes the associated lid shelves 24 to rotate in such a way as to release the bottom-most lid in the lid stack to the lid discharge area 16.

That is, each lid shelf 24 rotates coaxially with its corresponding shaft 22. In this regard, the lid shelves 24 also function as escapement components that rotate in response to rotating the common gear 28. Each lid shelf 24 rotates by a sufficient amount to allow the bottom-most lid from the stack of lids to escape the stack of lids by falling into a lid discharge area 16, such as a chute that holds the lid until the user removes the lid from the lid dispenser 10. The escapement features of the lid shelves 24 is described in greater detail below.

The illustrated lid dispensing mechanism 30 includes a rod 32 that is secured between side walls of the lid dispenser housing 12 for rotation in a direction generally orthogonal to the direction of rotation of the shafts 22. A lever arm 34 extends outward from the rod 32 generally towards each side wall of the dispenser housing 12 and each of the lever arms 34 are connected by a handle 36. In this arrangement, a user manually pulls or otherwise rotates the handle in a generally downward direction. As the handle is being pushed down, the respective lever arms 34 cause the rod 32 to rotate, thus transitioning the lid dispensing mechanism 30 from the non-actuated state to the actuated state.

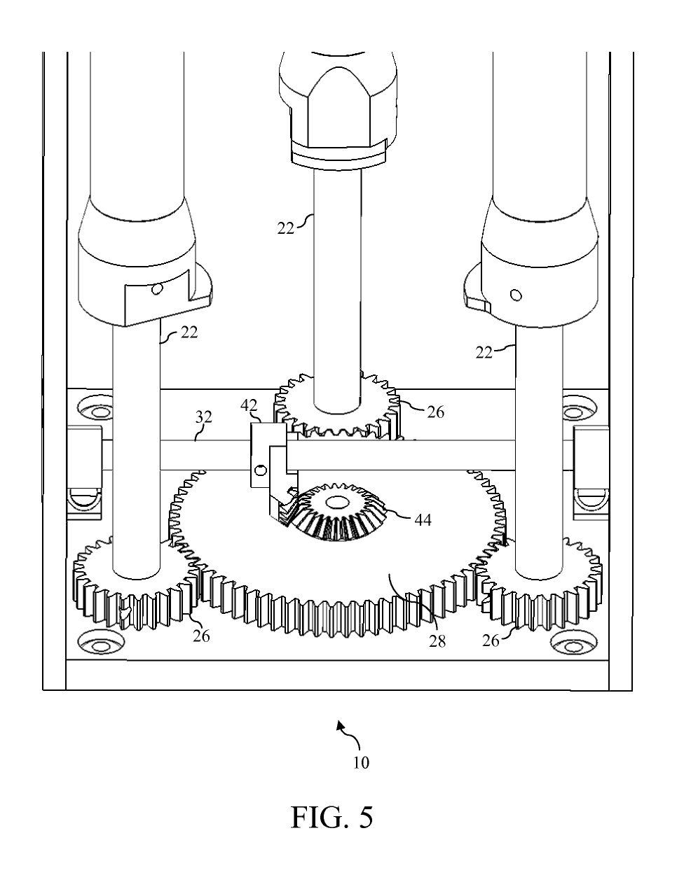

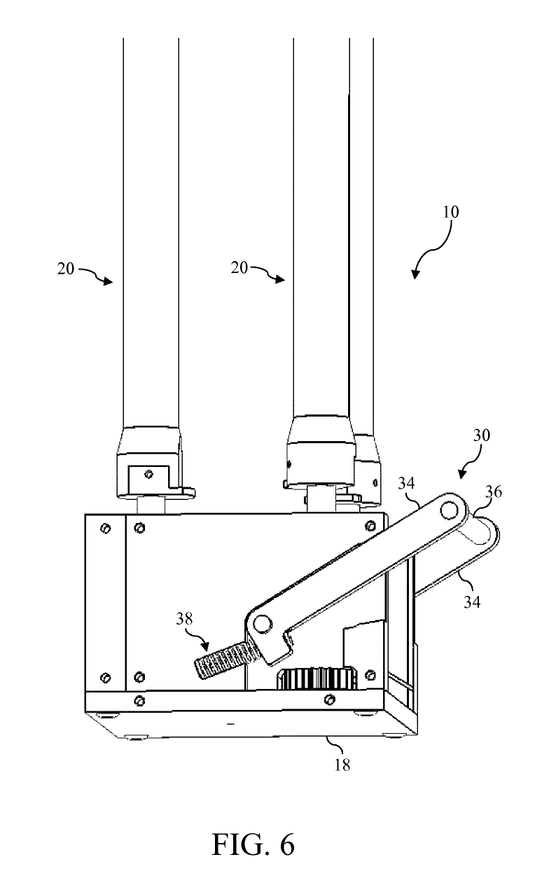

Referring generally to FIGS. 4-6, the lid dispensing mechanism 30 optionally also includes a spring biasing arrangement 38 (FIG. 6). The spring bias arrangement 38 provides a spring bias to the lever arms 34. As such, when the handle 36 is manually pressed by an operator to dispense a lid, such that manual depression of the handle 36 by the operator causes the transition of the lid dispensing mechanism 30 from the non-actuated state to the actuated state, a slight resistance is provided back to the operator. This provides a tactile response to the operator to inform the operator that a lid is about to be dispensed. The spring bias arrangement 38 also automatically returns the handle 36 to a “ready state” that transitions the lid dispensing mechanism 30 back to the non-actuated state. In this regard, the spring biased arrangement 38 may include a stop or other feature to limit the travel of the handle 36 in one or more directions. The spring biased arrangement 38 may be of any spring type including, but not limited to, a tension spring (as shown in FIG. 6), a compression spring, a torsion spring, a coil spring, a flat spring, and a rubber band. Further, if no automatic handle return arrangement is present, then an operator may be required to return the handle 36 to its non-depressed state.

According to various aspects of the present invention, a bevel gear assembly 40 is provided to convert rotation of the rod 32 (as a result of an operator manually pushing the handle 36), to rotation of the common gear 28, which causes corresponding rotation of the drive gears 26 and corresponding shafts 22, to dispense a lid. The bevel gear assembly 40 includes a first bevel gear 42 coupled to the rod 32 of the dispensing mechanism 30, and a second bevel gear 44 coupled to the common gear 28. As such, rotation of the rod 32 in a first rotational direction about a generally horizontal axis (e.g., transitioning the lid dispensing mechanism 30 from the non-actuated state to the actuated state via the spring biasing arrangement 38) causes rotation of the common gear 28 in a first rotational direction about a generally vertical axis. Correspondingly, rotation of the rod 32 in a second direction about the generally horizontal axis (e.g., transitioning the lid dispensing mechanism 30 from the actuated state back to the non-actuated state) causes rotation of the common gear 28 in a second rotational direction about the generally vertical axis. Thus, during an operating cycle to dispense a lid, the common gear 28 turns in the first direction to dispense a lid, then turns in the second direction to return to a default position. The bevel gear assembly may be of other types of gears including, but not limited to, hypoid, crown, and worm gears.

For purposes of illustration, the first bevel gear 42 comprises a “sector” circumference that does not extend in an entire circle, thus providing a gear that is only partially toothed for engagement with the second bevel gear 44. This arrangement may be utilized where the rotation of the rod 32 is limited, thus causing a corresponding limited amount of rotation of the first bevel gear 42.

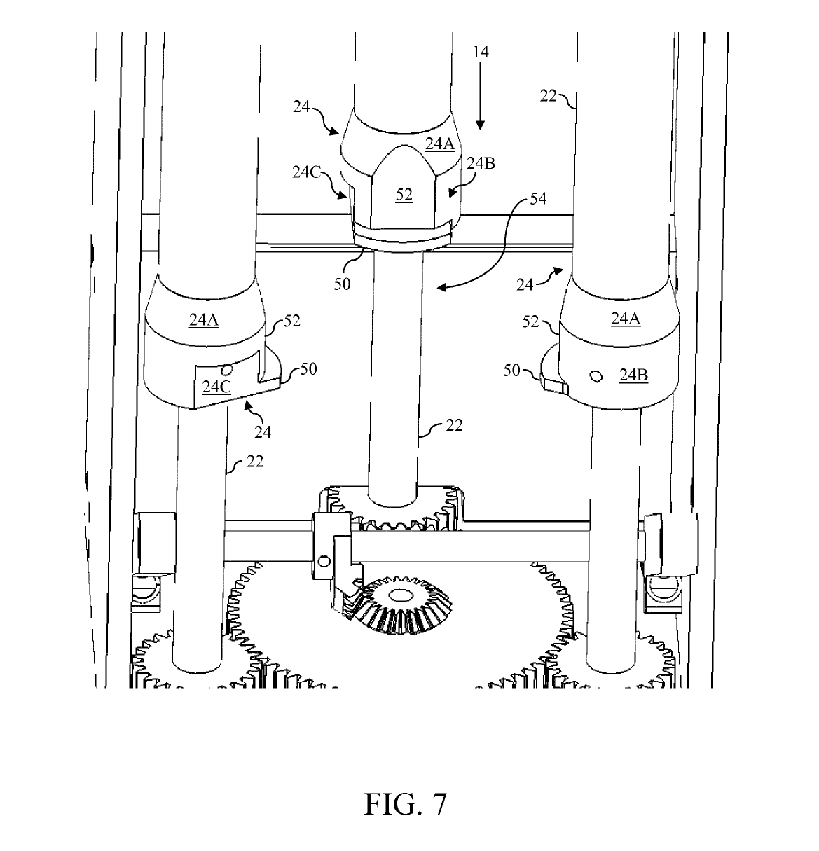

Referring to FIG. 7, according to various aspects of the present invention, each lid shelf 24 may comprise a lid dispensing flange 50 having a first surface defining a finger or ledge that extends out from the corresponding shaft 22 such that rotation of the shaft 22 causes corresponding rotation of the lid dispensing flange 50 in a generally horizontal plane. Accordingly, each lid dispensing flange 50 is in a first position engaged with at least a bottom-most lid when the manually operated dispensing mechanism is in the non-actuated state, and each lid dispensing flange 50 is rotated to a second position sufficient to release the bottom-most lid into the lid discharge area 16 when the manually operated dispensing mechanism 30 is in the actuated state.

Each lid shelf 24 may also include a lid channel surface 52 that contacts or otherwise is proximate to one or more lids when a stack of lids is inserted into the lid stack area and the lid dispensing mechanism 30 is in the non-actuated state. Each lid channel surface 52 rotates with its corresponding generally vertically extending shaft 22. The lid channel surface 52 may comprise, for example, a substantially flat, concave or otherwise curved surface extending perpendicular to, and above the corresponding lid dispensing flange 50. Moreover, as illustrated, each lid shelf 24 includes a profile that defines a “frustum”. This geometry provides a profile that tapers out towards the bottom of each lid shelf 24. This “tapering out” in turn, narrows the lid stack area 16 between the shafts 22 into a lid channel 54 at the escapement area where the bottom-most lid of a stack of lids installed into the dispenser 10 is discharged upon manual actuation of the lid dispensing mechanism 30.

When the lid dispensing mechanism 30 is in the non-actuated state, the lid channel surface 52 aligns with the periphery of the stack of lids allowing the stack of lids to pass between the shafts 22. In this regard, in the illustrative implementation, the lid channel surface 52 defines a contour in the profile of the corresponding lid shelf 24 so that a stack of lids can pass between the lid shelves 24 and the bottom-most lid can come to rest on the flange 50 of each of the corresponding lid shelves 24.

The lid dispenser 10 is particularly suited for serially dispensing lids, and more particularly, for sequentially dispensing a bottom-most lid from a substantially coaxially aligned stack of lids. In use, a stack of lids are lowered into the housing into the lid stack area until the bottom-most lid is brought to rest by the lid shelves 24.

As noted in greater detail herein, during actuation of the lid dispenser 10, each lid shelf 24 also functions as an escapement. In this regard, each lid shelf 24 may have a frustum, tapering feature or other similar attribute. For example, as best illustrated in FIG. 7, each lid shelf 24 has a smaller diameter portion 24A to allow lids to pass through and a larger diameter portion 24B to suspend the lids. This defines a narrowing of the lid stack area into a lid channel just before the lid discharge area where the bottom-most lid is dispensed. This feature also keeps lids moving down, e.g., by causing lids in the stack of lids to spin and automatically line up for dispensing. Each lid shelf 24 also includes a release feature 24C proximate to the corresponding flange 50 that defines a “cam profile” described in greater detail below.

When the operator produces the required motion to trigger the lid dispensing mechanism 30 of the lid dispenser 10, the shafts 22 and the lid shelves 24 rotate in a first rotational direction, e.g., counter clockwise. In this regard, the lid shelves 24 are now functioning as escapement components to drop the bottom-most lid by rotating a sufficient amount to allow the cam action of the escapements to work.

The lids stacked within the lid dispenser 10 are typically flexible lids. In an illustrative but non-limiting example, as the shafts 22 rotate in the first direction, the larger diameters 24B (i.e., compression portion) of the lid shelves 24 rotate to slightly compress one or more lids in the stack of lids, e.g., the lid that is second from the bottom. There is enough compression produced on this lid to hold the stack above the lid that is second from the bottom. The lid dispensing flanges 50 also rotate out from under the stack of lids and the release features 24C of the lid shelves 24 rotate in line with the bottommost lid.

The release features 24C provide a clearance for the bottom-most lid so that as the second from the bottom lid is suspended by the larger diameters 24B, the bottom-most lid is released from the stack though the release features or cam-action of the release feature 24C. Thus, the bottom-most lid drops out to a discharge area, e.g., a convenient location for the end user to pick up the dispensed lid.

When the dispensing mechanism 30 is released, the shafts 22 and correspondingly, the lid shelves 24 rotate back, i.e., they rotate in a direction opposite that to which they previously rotated in response to operation of the dispensing mechanism 30. Keeping with the above example, the shafts 22 rotate back in a clockwise direction to return to their default or rest position. In response thereto, the flanges 50 rotate back underneath the stack of lids and the larger diameters 24B of the lid shelves 24 rotate to release the slightly applied compression as the perimeter of the stack of lids is brought back in alignment with the lid channel surface 52. In response thereto, the entire stack of lids drops down to be supported by the lid shelves 24 and/or lid dispensing flanges 50. In this regard, the lid shelves 24 transition from the function of escapement back to the function of lid support.

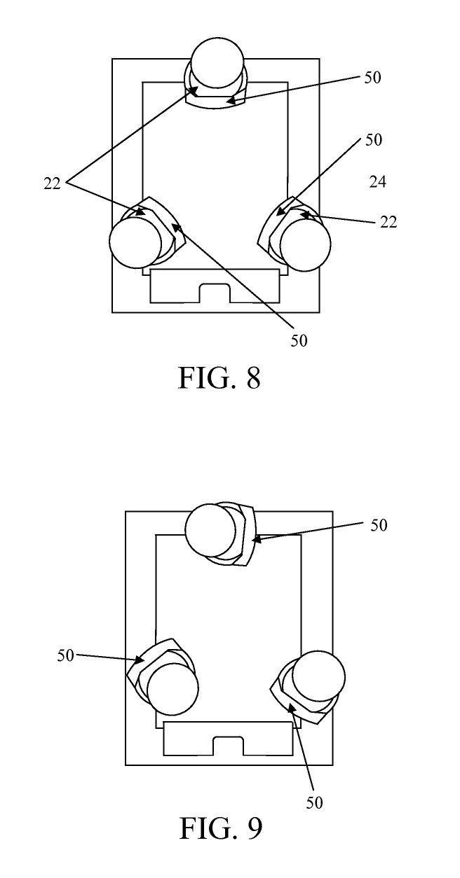

Referring to FIG. 8, an illustration looking down into the dispenser 10 illustrates the positioning of the shafts 22 and corresponding lid shelves 24 in the default position where the shelf 24 serves to support a loaded stack of lids. This default position is the non-actuated position. Correspondingly, referring to FIG. 9, an illustration looking down into the dispenser 10 illustrates the positioning of the shafts 22 and corresponding lid shelves 24 in the rotated position corresponding to operation of the dispensing mechanism 30. This rotated position is the actuated position. Notably, the flanges 50 have rotated counterclockwise compared to their position in FIG. 8. When the dispensing mechanism is released, the flanges 50 will rotate clockwise (in this exemplary configuration) back to their position illustrated in FIG. 8.

As noted in greater detail herein, the lids to be stacked within the lid dispenser 10 are typically flexible lids and are available in a variety of styles, sizes and materials. For example, flexible lids are often provided with cups for holding fountain drinks, coffee and other beverages. Such lids are often flexible concavo-convex plastic structures having a generally flat and circular top surface and an annular flanged rim extending from the top surface, allowing the lids to form in a stack. The annular flanged rim also provides a gripping surface for the lid to mate with a corresponding beverage container. However, certain lids, such as coffee container lids, may be taller than soft drink cup lids. Other lid types may have raised rims, inclined or outwardly flared edge portions, flares or flanges at their perimeter, etc., which affects the overall spacing between lids in the stack. In this regard, the lid shelves 24 accommodate the appropriate various lid configurations, or specific versions of the lid shelves can be utilized to accommodate specific features of the intended lids to be dispensed.

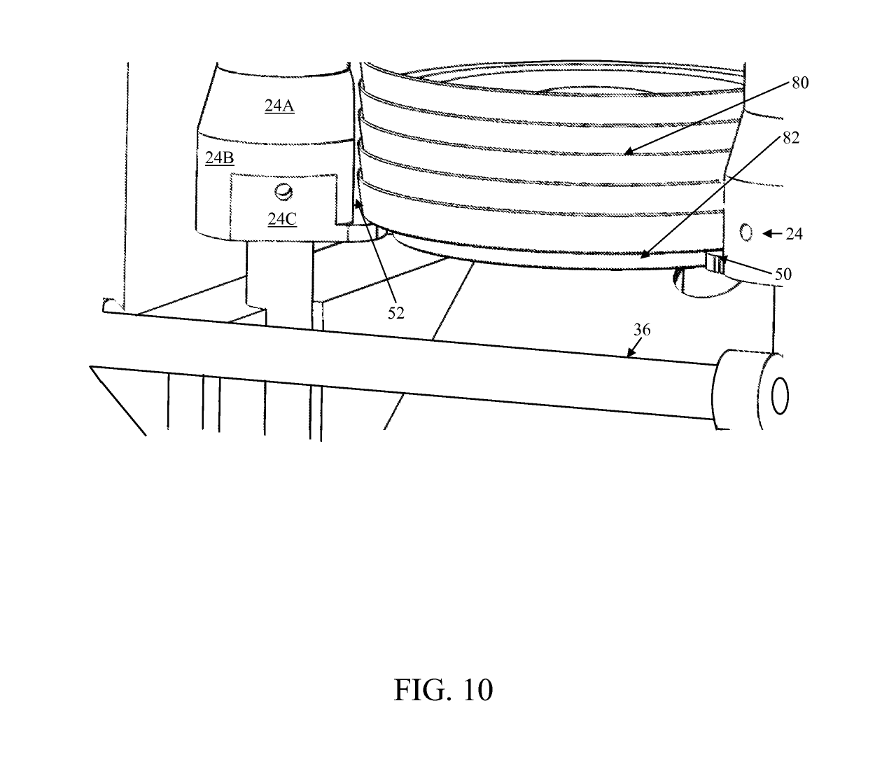

Referring to FIG. 10, a stack of lids 80 have been installed “upside down” within the lid storage area of the lid dispenser 10. In the illustrative example, installing the lids “upside down” allows the circular top surface of the bottom-most lid to rest on the flanges 50 of the lid shelves. Moreover, an upside down arrangement allows the rims of the lids to angle out and up relative to the corresponding lid top surfaces. This reduces snagging and catching within the lid dispenser, and facilitates dropping only the bottom-most lid 82 from the stack of lids 80.

As also illustrated, the lid channel surface 52 allows the stack of lids 80 to drop into the lid dispenser 10 such that the bottom-most lid is at rest on the flanges 50 of the corresponding lid shelves 24 and the remainder of the lids stack vertically upward. In this regard, the lid channel surface 52 allows the lids to descend freely towards the flanges 50 regardless of whether a particular lid in the stack of lids 80 is adjacent to the smaller diameter portion 24A of each lid shelf 24, or whether a particular lid in the stack of lids 80 is adjacent to the larger diameter portion 24B of each lid shelf 24.

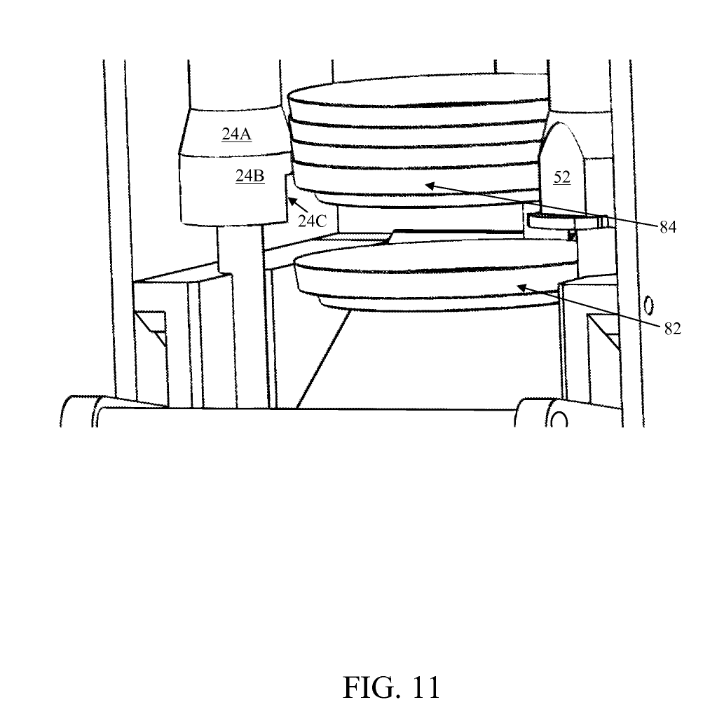

Referring to FIG. 11, upon operation of the dispensing control 30, each shaft 22 rotates (counterclockwise in this example), thus rotating the corresponding lid shelves 24. As the lid shelves 24 rotate, the lid channel surface 52 rotates away from the stack of lids 80. Moreover, the larger diameter portions 24B of the lid shelves 24 also rotate to slightly compress at least the lid that is second from the bottom. For example, the surface of 24B may apply a slight frictional pressure tangentially against a flanked portion or rim of the lids in the stack of lids 80. There is enough compression produced on the second from bottom lid 84 to hold the remainder of the lids in the stack of lids above.

Moreover, the flanges 50 rotate out from under the bottom-most lid 82 in the stack of lids 80. However, because the cam action of the release profile 24C of each lid shelf 24, and because the flange 50 of each lid shelf 24 has been rotated from underneath of the bottom-most lid 82, the bottom-most lid 82 is unencumbered by forces caused by the lid dispenser 10. Thus the bottom-most lid 82 is free to fall into the discharge area of the lid dispenser 10. Thus, the bottom-most lid 82 drops out to a convenient location for the end user to pick up. When the activation mechanism 30 is released, the shafts 22 and the corresponding lid shelves 24, which were just functioning as escapements to drop the bottom-most lid 82, rotate back to the rest position. When the lid shelves 24 rotate back to their rest position, the frictional relationship of the lids and corresponding diameter portions 24B of the lid shelves 24 is relieved as the lid channel surface 52 rotates back in alignment with the stack of lids, thus allowing the entire remaining stack of lids to drop down to be supported by the flanges 50.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

Having thus described the invention of the present application in detail and by reference to embodiments thereof, it will be apparent that modifications and variations are possible without departing from the scope of the invention defined in the appended claims.

What is claimed is:

1. A lid dispenser for sequentially dispensing flexible lids, comprising:
a housing including a housing base, a lid stack area for storing a substantially vertical stack of lids and a lid discharge area arranged to receive a bottom-most lid dispensed from the lid stack area;
a plurality of shaft assemblies arranged in a pattern that facilitates stacking a plurality of lids there between, wherein at least one of the plurality of shaft assemblies includes:
a generally vertically extending shaft;
a lid shelf positioned along the shaft that supports at least the bottom-most lid of a stack of lids positioned in the lid stack area; and
a drive gear attached about shaft so that rotation of the drive gear causes corresponding rotation of the attached shaft and corresponding lid shelf;
a common gear positioned so as to mesh with each of the drive gears such that rotation of the common gear causes rotation of each of the drive gears;
a lid dispensing mechanism coupled to the common gear, wherein:
manual operation of the lid dispensing mechanism from a non-actuated state to an actuated state causes the common gear to rotate sufficient to rotate each of the a plurality of shaft assemblies in a first direction and each of the shaft assemblies rotate about a corresponding vertical axis in such a manner as to cause the at least one lid shelf to release the bottom-most lid in the lid stack area to transition to the lid discharge area.

2. The lid dispenser according to claim 1, wherein:
the lid dispensing mechanism is configured to transition from the actuated state to a non-actuated such that the common gear is returned from its rotated position sufficient to rotate each of the plurality of shaft assemblies in a second direction opposite the first direction so as to cause the lid shelves to return to a position sufficient to support the bottom-most lid in the lid stack area.

3. The lid dispenser according to claim 1, wherein each lid shelf comprises:
a lid dispensing flange having a first surface that extends out from the corresponding shaft such that rotation of the shaft causes corresponding rotation of the lid dispensing flange, wherein:
each lid dispensing flange is in a first position engaged with at least a bottom-most lid when the manually operated dispensing mechanism is in a non-actuated state, and each lid dispensing flange is rotated to a second position sufficient to release the bottom-most lid to the lid discharge area when the manually operated dispensing mechanism is in the actuated state.

4. The lid dispenser according to claim 3, wherein each lid shelf further comprises:
a lid channel surface that is proximate to at least one lid when a stack of lids is inserted into the lid stack area, each lid channel surface arranged to rotate with its corresponding generally vertically extending shaft.

5. The lid dispenser according to claim 4, wherein each lid channel surface is proximate to and contacts at least one lid when a stack of lids is inserted into the lid stack area.

6. The lid dispenser according to claim 4, wherein each lid channel surface comprises a surface extending perpendicular to, and above the corresponding lid dispensing flange.

7. The lid dispenser according to claim 1, wherein:
the lid shelf includes a frustum that narrows the lid stack area into a lid channel.

8. The lid dispenser according to claim 1, wherein:
the lid dispensing mechanism comprises a spring biased lever arrangement having a handle that is manually pressed by an operator to dispense a lid such that manual depression of the handle by the operator causes the transition from the non-actuated state to the actuated state.

9. The lid dispenser according to claim 1, wherein:
the lid dispensing mechanism comprises a handle that is manually pressed by an operator to dispense a lid such that manual depression of the handle by the operator causes a corresponding shaft to rotate;
further comprising:
a bevel gear assembly that couples the shaft to the common gear such that rotation of the shaft in a first rotational direction causes rotation of the common gear in a second rotational direction different from the first rotational direction.

10. The lid dispenser according to claim 9, wherein:
the bevel gear assembly includes a first bevel gear coupled to the shaft and a second bevel gear coupled to the common gear; and
the first bevel gear comprises a sector circumference that does not extend in an entire circle.

11. The lid dispenser according to claim 1, wherein:
each of the shafts is journaled into the base.

12. The lid dispenser according to claim 1, wherein:
the plurality of shaft assemblies comprises at least three shaft assemblies.

13. The lid dispenser according to claim 1, wherein:
each of the shafts comprises a generally cylindrical rod that extends generally vertically and is rotatable about a corresponding substantially vertical axis.

14. The lid dispenser according to claim 1, wherein:
the rotation of the common gear is limited to an amount sufficient to pass the bottom-most lid of the stack of flexible lids into the discharge area.

15. The lid dispenser according to claim 1, wherein the shafts rotate about an axis substantially parallel to the lid stack when the lid dispensing mechanism is activated.

16. A method of dispensing a lid from a stack of lids when an operator depresses a handle, the method comprising:
pre-loading a stack of lids between a plurality of shaft assemblies in a non-activated position such that the stack of lids rests on a plurality of lid dispensing flanges, the stack of lids comprising a bottom-most lid and a remaining portion of lids; and
rotating the plurality of shaft assemblies to an activated position such that:
the plurality of lid dispensing flanges rotates such that the stack of lids does not rest on the lid dispensing flange;
the bottom-most lid to falls to a lid discharge area; and
a compression portion of the plurality of shaft assemblies compresses the remaining portion of lids such that the remaining portion of lids is suspended and does not fall to the lid discharge area.

17. The method of claim 16, wherein pre-loading a stack of lids further comprises orienting the stack of lids upside-down.

18. A lid dispenser for sequentially dispensing flexible lids, comprising:
a plurality of vertically extending shaft assemblies arranged in a pattern that facilitates stacking a plurality of lids there between, the plurality of lids including a bottom-most lid and a remaining portion, wherein:
the plurality of shaft assemblies includes at least two positions: an activated position and a non-activated position; and
at least one of the plurality of shaft assemblies includes:
a lid shelf positioned along the shaft arranged such that, when the plurality of shaft assemblies is in the non-activated position, supports at least the bottom-most lid positioned within the plurality of shaft assemblies, and when the plurality of shaft assemblies is in the activated position allows the bottom-most lid to fall free; and
a compression portion along the shaft that, when the plurality of shaft assemblies is in the activated position, compresses the remaining portion of the plurality of lids and suspends the remaining portion of the plurality of lids from falling free.

19. The lid dispenser according to claim 18, wherein each lid shelf comprises:
a lid dispensing flange having a first surface that extends out from the corresponding shaft such that rotation of the shaft causes corresponding rotation of the lid dispensing flange, wherein:
each lid dispensing flange is in a first position engaged with at least a bottom-most lid when a manually operated dispensing mechanism is in a non-actuated state, and each lid dispensing flange is rotated to a second position sufficient to release the bottom-most lid to the lid discharge area when the manually operated dispensing mechanism is in the actuated state; and
a lid channel surface that is proximate to at least one lid when a stack of lids is inserted into the lid stack area, each lid channel surface arranged to rotate with its corresponding generally vertically extending shaft.

20. The lid dispenser according to claim 19, wherein the lid shelf further comprises:
a release profile adjacent to the flange for providing a cam action to release the bottom-most lid.
